(19) United States
(12) Patent Application Publication
(10) Pub. No.: US 2017/0085807 A1
(43) Pub. Date: Mar. 23, 2017

(54) VIDEO SIGNAL TRANSMISSION SYSTEM AND DISPLAY APPARATUS

(71) Applicant: DENSO CORPORATION, Kariya-city, Aichi-pref. (JP)

(72) Inventors: Teruhiro TSUJIOKA, Kariya-city (JP); Takahiro KAMO, Kariya-city (JP)

(21) Appl. No.: 15/310,486

(22) PCT Filed: May 21, 2015
(86) PCT No.: PCT/JP2015/002564

§ 371 Date: Nov. 11, 2016

(30) Foreign Application Priority Data
May 28, 2014 (JP) 2014-110190

(51) Int. Cl. H04N 5/268; G06F 3/14; G09G 5/00; H04N 5/38

(52) U.S. Cl. CPC H04N 5/268; H04N 5/38; G06F 3/1446; G09G 5/006; G09G 2380/10

(57) ABSTRACT

A video signal transmission system which includes a video transmission apparatus and a main-display apparatus and in which a sub-display apparatus is connectable between the video transmission apparatus and the main-display apparatus is provided. The video transmission apparatus transmits a video signal in which video data of a main-screen and video data of sub-screen is stored collectively. The main display apparatus separate the video data of the main-screen from the received video signal and displays the main-screen. When the sub-display apparatus is connected between the video transmission apparatus and the main-display apparatus, the sub-display apparatus separates the video data of the sub-screen from the video signal received from the video transmission apparatus for another sub-display apparatus on a signal source side and displays the sub-screen and transmits the video signal to the main-display apparatus or another sub-display apparatus on a main-display apparatus side.

### CROSS REFERENCE TO RELATED APPLICATION

This application is based on Japanese Patent Application No. 2014-110190 filed on May 28, 2014, disclosure of which is incorporated herein by reference.

### TECHNICAL FIELD

The present disclosure relates to a video signal transmission system including one video transmission apparatus and one or more display apparatuses, and to a display apparatus.

### BACKGROUND ART

Conventionally, a video signal transmission system including a single video transmission apparatus and one or more display apparatuses is provided. In the configuration in which one video signal apparatus is connected to one or more display apparatuses, multiple GDCs (Graphics Display Controllers) corresponding to multiple display apparatuses are required and multiple transmitters corresponding to the multiple GDCs are further required. This configuration in which multiple GDCs and transmitters are required for the video transmission apparatus involves a problem of complication of a configuration of the video transmission apparatus and high cost. Additionally, when multiple GDCs and transmitters are provided on assumption that multiple display apparatuses are connected, if only part of the multiple display apparatuses are connected and only part of the GDCs and transmitters are used, the rest of the GDCs and transmitters becomes a waste.

For addressing this problem, Patent Literature 1 discloses a configuration of a video transmission apparatus, in which a GDC creates a video signal collectively storing video date of respective screens and an ASIC (Application Specific Integrated Circuit) separates the video date.

### PRIOR ART LITERATURE

### Patent Literature

Patent Literature 1: JP 2013-213859A

### SUMMARY OF INVENTION

The inventor of this application found out the following regarding the technology disclosed in Patent Literature 1. In the technology disclosed in Patent Literature 1, a single GDC suffices in the video transmission apparatus but multiple transmitters corresponding to multiple display apparatuses are still required because the video date collectively storing the video data of respective screens is separated by an ASIC. Additionally, if only part of the transmitters is used, the rest of the transmitters become a waste too. As a result, a configuration complication and cost increase of the system as a whole occur.

The present disclosure is made in view of the foregoing and has an object to provide a video transmission apparatus and a display device that enables configuration simplification and cost reduction of a system as a whole.

A video signal transmission system in a first aspect of the present disclosure is configured such that one or more sub-display apparatuses for displaying a sub-screen are connectable between a video transmission apparatus for transmitting a video signal and a main-display apparatus for displaying a main-screen. The video transmission apparatus transmits the video signal, in which video date of the main-screen and video data of the sub-screen are stored collectively. The main-display apparatus separates the video data for the main-display apparatus from the video signal received via the sub-display apparatus or received directly from the video transmission apparatus and displays the main-screen. In a case where the sub-display apparatus is connected between the video transmission apparatus and the main-display apparatus, the sub-display apparatus separates the video date for the sub-display apparatus from the video signal received from the video transmission apparatus or another sub-display apparatus connected between the sub-display apparatus and the video transmission apparatus and displays the sub-screen and transmits the video signal to the main-display apparatus or yet another sub-display apparatus connected between the sub-display apparatus and the main-display apparatus.

In the video signal transmission system, because the video transmission apparatus transmits the video signal in which the video data of the main-screen and the video data of the sub-screen are stored collectively, even when the system as a whole includes multiple display apparatuses, it becomes unnecessary to provide multiple transmitters corresponding to the multiple display apparatuses (one main-display apparatus and one or more sub-display apparatuses). Specifically, the single transmitter suffices and accordingly a configuration simplification and cost reduction of the video transmission apparatus are achieved. Additionally, even when the sub-display apparatus is not connected, a waste transmitter does not appear in the video transmission apparatus. In this case, there may be a concern that the sub-display apparatus requires a transmitter for transmitting the video signal to the main-display apparatus or another sub-display apparatus on a main-display side and configuration complication and cost increase of the sub-display apparatus occur. However, the main-display apparatus is standard equipment and the sub-display apparatus is an optional extra. When the percentage of equipping (connecting) the sub-display apparatus is low, the configuration simplification and cost reduction of the video transmission apparatus have a larger influence on the system as a whole than the configuration complication and cost increase of the optional extra sub-display apparatus. As a result, the configuration simplification and cost reduction of the system as a whole are achieved.

In a second aspect of the present disclosure, a display apparatus functioning as one main-display apparatus in a video signal transmission system is provided. The signal transmission system includes one video transmission apparatus for transmitting a video signal and the one main display apparatus for displaying a main-screen and one or more sub-display apparatuses are connectable between the video transmission apparatus and the main display apparatus and the video transmission apparatus transmits the video signal in which video data of the main-screen and video data of the sub-screen are stored collectively. The display apparatus comprises: a main-receiver for receiving the video signal from the video transmission apparatus or from a sub-display apparatus connected between the video transmission apparatus and the main-display apparatus; a main-separator for separating the video data of the main-screen for the main-display apparatus from the video signal received by the main-receiver; and a main-display unit for displaying the main-screen based on the video data separated by the main-separator.

In a third aspect of the present disclosure, a display apparatus functioning as a sub-display apparatus in a video signal transmission system is provided. The video transmission apparatus includes one video transmission apparatus for transmitting a video signal and one main-display apparatus for displaying a main-screen, and one or more sub-display apparatuses are connectable between the video transmission apparatus and the main-display apparatus and the video transmission apparatus transmits the video signal in which video data of the main-screen and video data of the sub-screen are stored collectively. The display apparatus comprises: a sub-receiver for receiving the video signal from the video transmission apparatus or from another sub-display apparatus connected between the display apparatus and the video transmission apparatus; a sub-separator for separating the video data of the sub-screen from the display apparatus from the video signal received by the sub-receiver; a sub-display unit for displaying the sub-screen based on the video data separated by the sub-separator; and a sub-transmitter for transmitting the video signal, which is received by the sub-receiver, to the main-display apparatus or yet another sub-display apparatus connected between the display apparatus and the main-display apparatus.

### BRIEF DESCRIPTION OF DRAWINGS

The above and other objects, features and advantages of the present disclosure will become more apparent from the below detailed description made with reference to the accompanying drawings. In the drawings:

FIG. 1A is a functional block diagram illustrating a first embodiment when a sub-display is connected;

FIG. 1B is a functional block diagram illustrating the first embodiment when the sub-display is not connected;

FIG. 2 is a diagram illustrating a video data separation manner;

FIG. 3 is a functional block diagram of a first comparative example;

FIG. 4 is a functional block diagram of a second comparative example;

FIG. 5 is a diagram illustrating a video data separation manner in a second embodiment; and

FIG. 6 is a diagram illustrating a video data separation manner in a third embodiment.

### EMBODIMENTS FOR CARRYING OUT INVENTION

### First Embodiment

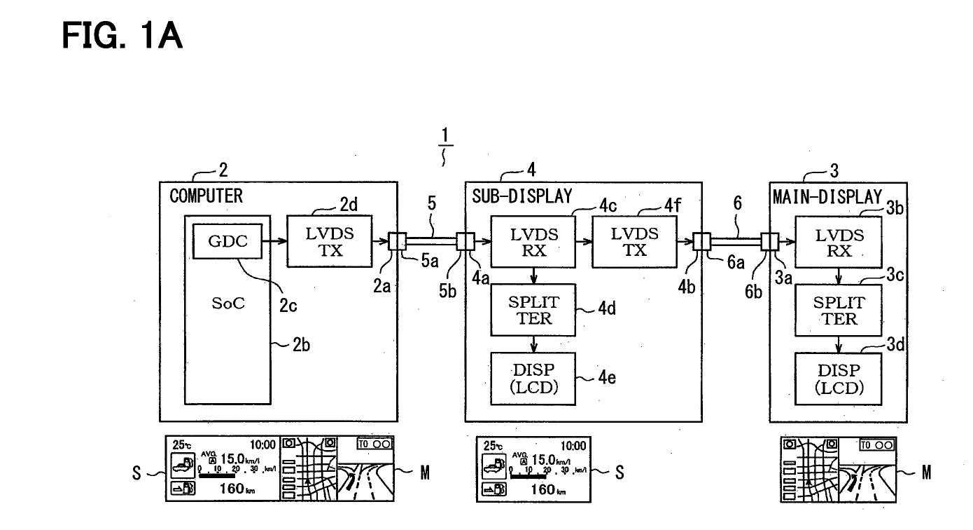

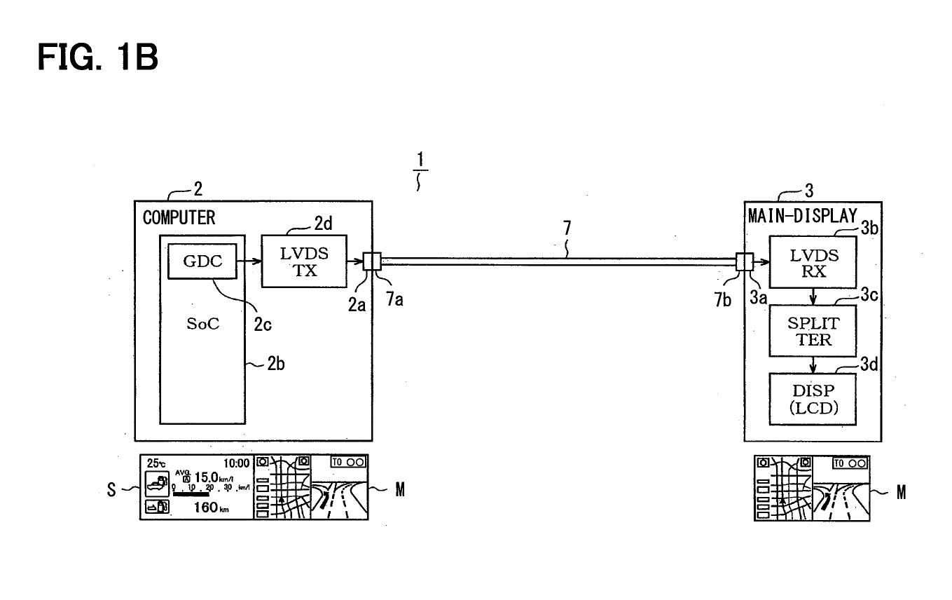

A first embodiment will be described with reference to FIG. 1 to FIG. 4. The first embodiment is directed to a video signal transmission system, which is mountable to a vehicle and which uses a LVDS (Low voltage differential signaling) as a video transmission interface. The video signal transmission system 1 is mountable to a vehicle and includes a computer 2 (corresponding to an example of a video transmission apparatus) and a main-display 3 (corresponding to an example of a main-display apparatus), and is configured so that a sub-display 4 (corresponding to an example of a sub-display apparatus) is connectable between the computer 2 and the main-display 3. The main-display 3 is a standard equipment display and the sub-display 4 is an optional extra display. Specifically, a user (e.g., owner) of the vehicle equipped with the video signal transmission system 1 can make a choice as to whether to mount (connect) the sub-display 4.

As shown in FIG. 1A, one sub-display 4 is connected between the computer 2 and the main-display 3. In this configuration, when a connector 5a at one end of a connection cable 5 is connected (plugged) to a connector 2a of the computer 2 and a connector 5b at the other end of the connection cable 5 is connected to a connector 4a of the sub-display 4, a LVDS signal becomes transmittable from the computer 2 to the sub-display 4. Additionally, when a connector 6a at one end of a connection cable 6 is connected to a connector 4b of the sub-display 4 and a connector 6b at the other end of the connection cable 6 is connected to a connector 3a of the main-display 3, the LVDS signal becomes transmittable from the sub-display 4 to the main-display 3. The number of sub-displays 4 connected between the computer 2 and the main-display 3 may be two or more. A communication interface between the computer 2 and the sub-display 4 and a communication interface between the sub-display 4 and the main-display 3 are the same (common).

As shown in FIG. 1B, the sub-display 4 may not be connected between the computer 2 and the main-display 3. In this configuration, when a connector 7a at one end of a connection cable 7 is connected to a connector 2a of the computer 2 and a connector 7b at the other end of a connection cable 7 is connected to a connector 3a of the main-display 3, the LVDS signal becomes transmittable from the computer 2 to the main-display 3. A communication interface between the computer 2 and the main-display 3 is the same as the above described communication interface between the computer 2 and the sub-display 4 and communication interface between the sub-display 4 and the main-display 3. Specifically, the connection cables 5 to 7 having the same specifications are supported.

The computer 2 includes a GDC (Graphics Display Controller) 2c mounted on a SoC (System on Chip) 2b and further includes a transmitter (LVDS TX) 2d. The GDC 2c outputs video data to the transmitter 2d. When the transmitter 2d receives an input of the video data from the GDC 2c, the transmitter 2d performs protocol conversion to the video data into LVDS standards to generate a LVDS signal (video signal) and transmits the generated LVDS signal. Specifically, when the sub-display 4 is connected between the computer 2 and the main-display 3, the computer 2 transmits the LVDS signal to the sub-display 4. When the sub-display 4 is not connected between the computer 2 and the main-display 3, the computer 2 transmits the LVDS signal to the main-display 3. The computer 2 may transmit the LVDS signal containing the image data generated by the computer 2. The computer 2 may transmit the LVDS signal containing the image data inputted from an outside.

The main-display 3 includes a receiver 3b (LVDS RX), a splitter 3c and a display unit 3d. When the sub-display 4 is connected between the computer 2 and the main-display 3, the receiver 3b outputs, to the splitter 3c, the LVDS signal received from the computer 2 via the sub-display 4. When the sub-display 4 is not connected between the computer 2 and the main-display 3, the receiver 3b outputs, to the splitter 3c, the LVDS signal received directly from the computer 2. When the splitter 3c receives the LVDS signal from the receiver 3b, the splitter 3c extracts and separates video data of a main-screen M for the main-display 3 from the LVDS signal and outputs the separated video data to the display unit 3d. The splitter 3c discards image data other than the image data of the main-screen M. When receiving an input of the image data from the splitter 3c, the display unit 3d constructs and displays the main-screen M based on the video data. Although a screen relating to a map and route guidance of a navigation function is shown as an example of the main-screen M in FIG. 1, any screens may be employed. The receiver 3b corresponds to examples of a main-receiving means and a main-receiver. The splitter 3c corresponds to examples of a main-separation means and a main-separator. The display unit 3d corresponds to examples of a main-display means and a main-display unit.

The sub-display 4 includes a receiver 4c (LVDS RX), a splitter 4d, a display unit 4e, and a transmitter 4f (LVDS TX). When the sub-display 4 is connected between the computer 2 and the main-display 3, the receiver 4c outputs, to the transmitter 4f and the splitter 4d, the LVDS signal received from the computer 2 or another sub-display 4 connected between the sub-display 4 and the computer 2. When the splitter 4d receives an input of the LVDS signal from the receiver 4c, the splitter 4d extracts and separates video data of the sub-screen S and outputs the separated video data to the display unit 4e. The splitter 4d discards image data other than the image data of the sub-screen S. When receiving an input of the image data from the splitter 4d, the display unit 4e constructs and displays the sub-screen S based on the video data. When receiving an input of the LVDS signal from the receiver 4c, the transmitter 4f transmits the LVDS signal to the main-display 3 or another sub-display 4 connected between the sub-display 4 and the main-display 3. Although a screen relating to fuel efficiency is shown as an example of the sub-screen S in FIG. 1, any screens may be employed. The receiver 4c corresponds to examples of a sub-receiving means and a sub-receiver. The splitter 4d corresponds to examples of a sub-separation means and a sub-separator. The display unit 4e corresponds to examples of a sub-display means and a sub-display unit. The transmitter 4f corresponds to examples of a sub-transmission means and a sub-transmitter.

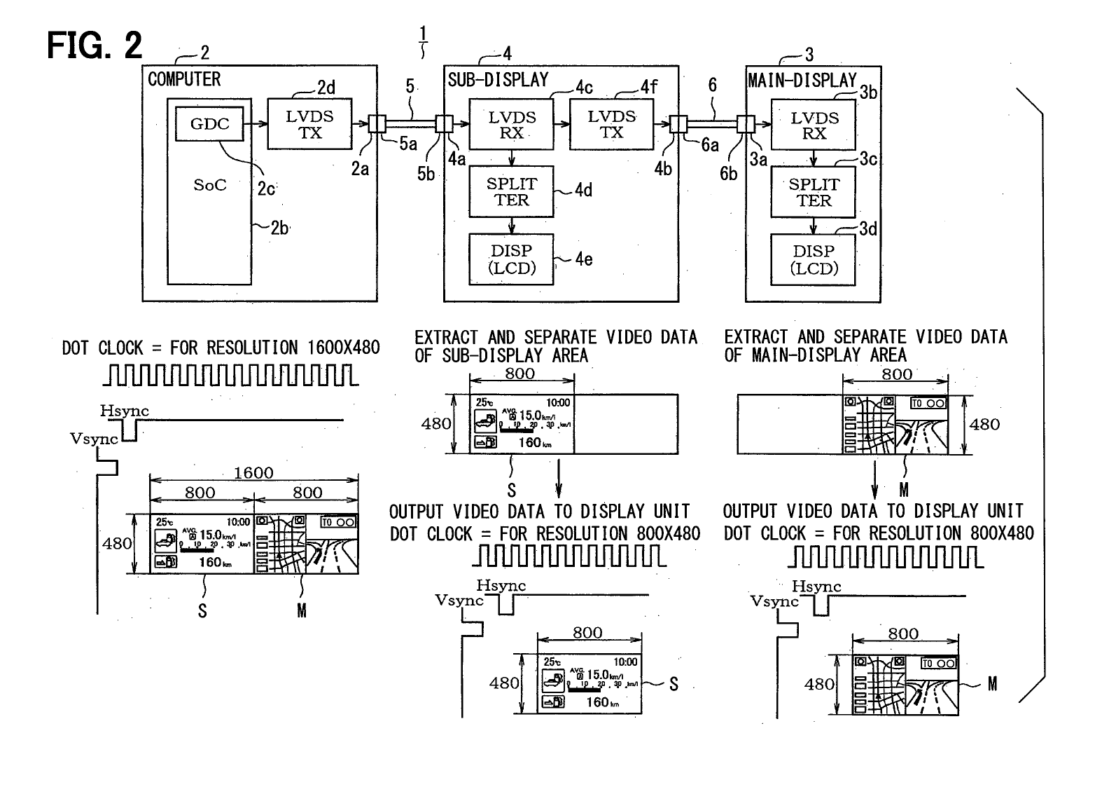

Next, operations in the above configurations will be described with reference to FIG. 2.

In the above configuration, the GDC 2c in the computer 2 generates video data in which the video data of the main-screen M and the video data of the sub-screen S are stored collectively and arranged side by side in a horizontal direction. The GDC 2c transmits the generated video data to the transmitter 2d. When the transmitter 2d receives an input of the video data from the GDC 2c, the transmitter 2d transmits the LVDS signal having a resolution that corresponds to a total sum of a resolution of the main-screen M and a resolution of the sub-screen S. Specifically, when the resolution of the main-screen M is 800×480 and the resolution of the sub-display S is 800×480, the transmitter 2d transmits the LVDS signal having a resolution of 1600×480 by horizontally arranging the main-display M and the sub-display S side by side.

When the sub-display 4 is connected between the computer 2 and the main-display 3 and the receiver 4c of the sub-display 4 receives the LVDS signal having the resolution of 1600×480 from the computer 2, the splitter 4d extracts and separates the video data corresponding to an area of the sub-display 4 from the received LVDS signal. In the sub-display 4, the separated video data is outputted to the display unit 4e and the sub-screen S is constructed from the video data and displayed by the display unit 4e. Additionally, in the sub-display 4, the LVDS signal received from the computer 2 and having the resolution of 1600×480 is transmitted from the transmitter 4f to the main-display 3.

When the receiver 3b of the main-display 3 receives the LVDS signal having the resolution of 1600×480 from the computer 2 via the sub-display 4, the splitter 3c extracts and separates the video data corresponding to an area of the main-display from the received LVDS signal. In the main-display 3, the separated video data is outputted to the display unit 3d and the main-screen M is constructed from the video data is displayed by the display unit 3d.

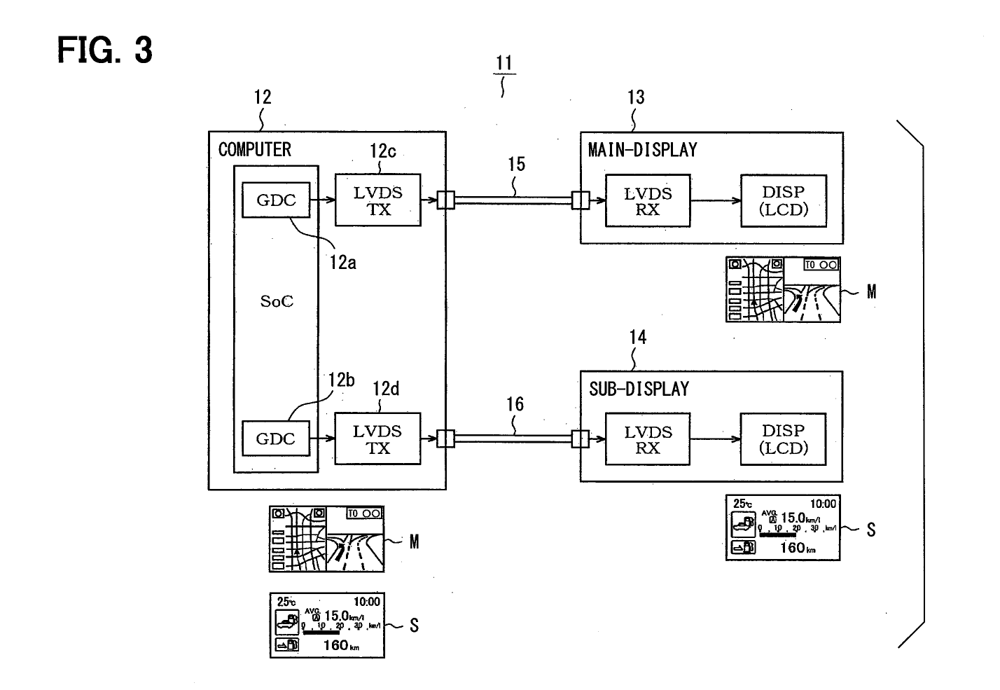

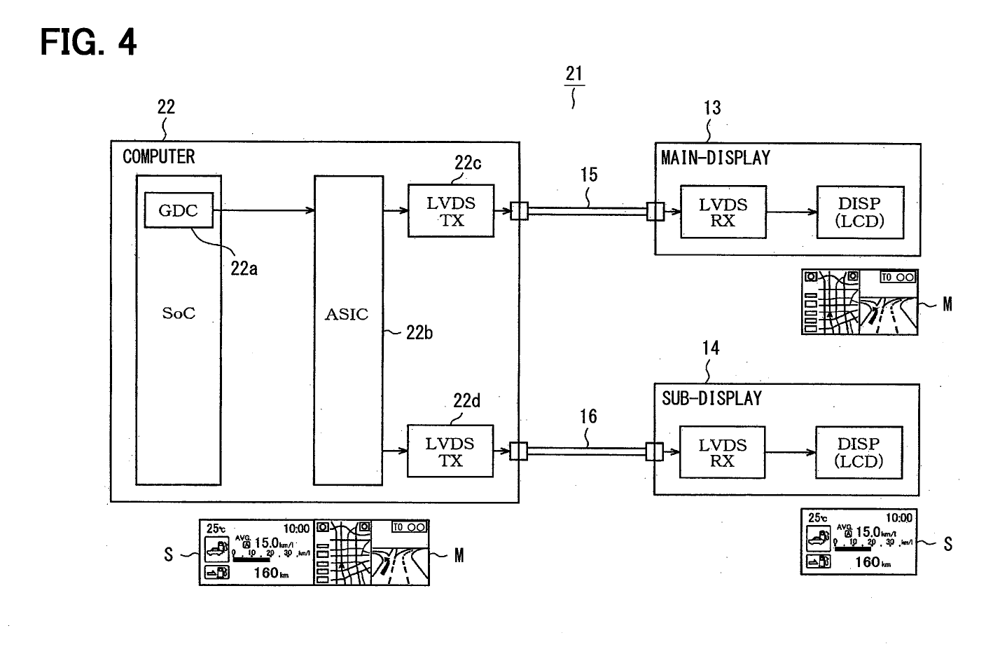

In the above configuration, the configuration of the computer 2 is simplified as compared with comparative examples shown in FIG. 3 and FIG. 4. Specifically, in a video signal transmission system 11 shown in FIG. 3, a computer 12 and a main-display 13 are connected via a connection cable 15 and the computer 12 and a sub-display 14 are connected via a connection cable 16. In this configuration, when video data of the main-screen M and video data of the sub-screen S are separately generated in the computer 12, two GDCs 12a, 12b are required and two transmitters 12c, 12d corresponding to the two GDCs 12a, 12b are required. In a video signal transmission system 11 shown in FIG. 4, when a GDC 22a in a computer 22 generates video data in which video data of the main-screen M and video data of the sub-screen S are stored collectively and arranged side by side horizontally and an ASIC 22b splits the video data, a single GDC 22a suffices but two transmitters 12c, 12d are required. In contrast to these comparative examples, the single GDC 2c and the single transmitter 2d suffice in the configuration of the present embodiment and accordingly the configuration of the computer 2 is simplified.

In the above illustration, the GDC 2c generates the video data in which the video data of the main-screen M and the video data of the sub-screen S are stored collectively and arranged side by side horizontally. Alternatively, the video data in which the video data of the main-screen M and the video data of the sub-screen S are stored collectively and arranged side by side vertically may be generated. In this case, the transmitter 2d generates the LVDS signal having a resolution of 800×960 by vertically arranging the main-screen M and the sub-screen S.

In the above illustrated first embodiment, because the computer 2 transmits the LVDS signal in which the video data of the main-screen M and the video data of the sub-screen S are stored collectively, it becomes unnecessary to provide two transmitters corresponding to the main-display 3 and the sub-display 4. Specifically, the single transmitter 2c may suffice, and accordingly, the simplification of the configuration of the computer 2 and the cost reduction can be achieved. Moreover, even when the sub-display 4 is not connected, there is no wasted transmitter in the computer 2. In this regard, there may be a concern that the sub-display 4 requires the transmitter 4f and the connector 4b (cannot have the same configuration as the main-display 3) and this complicates the configuration of the sub-display 4 and increases the cost as compared with the sub-display 14 of the comparative examples. However, the main-display 3 is standard equipment and the sub-display 4 is an optional extra. Thus, as long as the percentage of equipping the sub-display 4 (percentage of connecting) is small, the configuration simplification and cost reduction of the of the computer 2 have a larger influence on the system as a whole than the configuration complication and cost increase of the of the sub-display 4. As a result, the configuration simplification and the cost reduction of the system as a whole are achieved.

### Second Embodiment

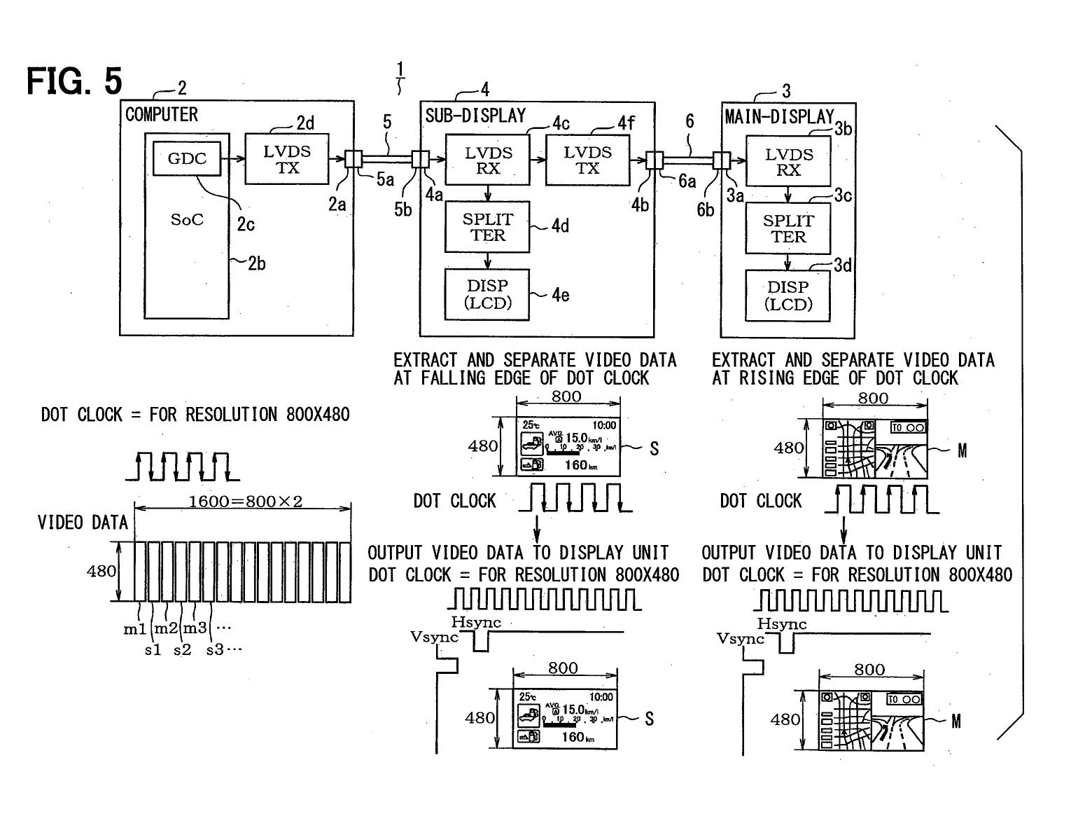

Next, a second embodiment will be described with reference to FIG. 5. Description of the same parts as those in the first embodiment will be omitted and different parts will be described. The second embodiment differs from the first embodiment in that in transmitting the video data collectively storing the video data of the main-screen M and the video data of the sub-screen S, the computer 2 transmits a LVDS signal in which the video data of the main-screen M and the video data of the sub-screen S are arranged alternately from pixel to pixel.

Specifically, the computer 2 captures the image data (m1, m2, m3, . . . ) of the main-screen M at a rising edge of a dot clock (an inverse number of a time needed to display one dot) and captures the image data (s1, s2, s3, . . . ) of the sub-screen S at a falling edge of the dot clock, thereby transmitting the LVDS signal in which the video data of the main-screen M and the video data of the sub-screen S are arranged alternately from pixel to pixel.

When the sub-display 4 is connected between the computer 2 and the main-display 3 and receives the LVDS signal from the computer 2, the splitter 4d extracts and separates the video data corresponding to the falling edge of the dot clock from the received LVDS signal. In the sub-display 4, the separated video data is outputted to the display unit 4e and the sub-screen S is constructed from the video data and displayed by the display unit 4e. The LVDS signal which the sub-display 4 received from the computer 2 is transmitted from the transmitter 4f to the main-display 3.

When the main-display 3 receives the LVDS signal from the computer 2 via the sub-display 4, the splitter 3c extracts and separates the video signal corresponding to the rising edge of the dot clock from the received LVDS signal. In the main-display 3, the separated video data is outputted to the display unit 3d and the main-screen M is constructed from the video data and displayed by the display unit 3e.

In the above, the computer 2 captures the video data of the main-screen M at the rising edge of the dot clock and captures the video data of the sub-screen S at the falling edge of the dot clock. The video data captured at the rising edge and the falling edge may be reversed. Specifically, the computer 2 may capture the video data of the sub-screen S at the rising edge of the dot clock and capture the video data of the main-screen M at the falling edge of the dot clock. The second embodiments provide the same technical advantages as the first embodiment. Specifically, because the LVDS signal into which the video data of the main-screen M and the video data of the sub-screen S are compiled is transmitted, the single transmitter 2c may suffice and accordingly the simplification of the configuration of the computer 2 is simplified.

### Third Embodiment

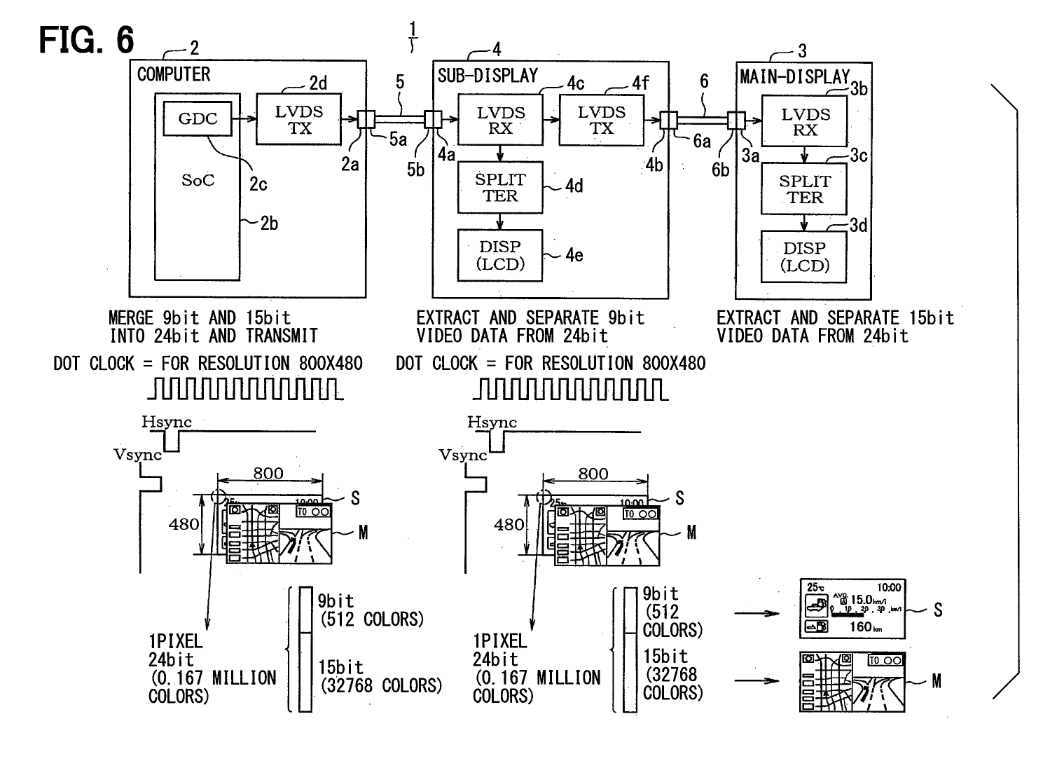

Next, a third embodiment will be described with reference to FIG. 6. Description of the same parts as those in the first embodiment will be omitted and different parts will be described. The third embodiment differs from the first embodiment in that in transmitting the video data collectively storing the video data of the main-screen M and the video data of the sub-screen S, the computer 2 transmits a LVDS signal having a bit number per pixel that corresponds to a total sum of a bit number per pixel of the video data of the main-screen and a bit number per pixel of the video data of the sub-screen.

For example, when the bit number per pixel of the video data of the main-screen M is 15 bits and the bit number per pixel of the video data of the sub-screen S is 9 bits, the computer 2 merges 15 bits and 9 bits into 24 bits notation data to transmit the LVDS signal having 24 bits as a bit number per pixel.

When the sub-display 4 is connected between the computer 2 and the main-display 3 and receives the LVDS signal from the computer 2, the splitter 4d extracts and separates the video data described in 9 bits from the received LVDS signal with 24 bits per pixel. In the sub-display 4, the separated video data is outputted to the display unit 4e and the sub-screen S is constructed from the video data and displayed by the display unit 4e. Additionally, the LVDS signal received from the computer 2 is transmitted from the transmitter 4f of the sub-display 4 to the main-display 3.

When the main-display 3 receives the LVDS signal form the computer 2 via the sub-display 4, the splitter 3c extracts and separates video data described in 15 bit from the LVDS signal with 24 bits per pixel. In the main-display 3, the separated video data is outputted to the display unit 3d and the main-screen M is constructed from the video data and displayed by the display unit 3d.

In the above illustration, the bit number per pixel of the video data of the main-screen M is 15 bits and the bit number per pixel of the video data of the sub-screen S is 9 bits. However, any values may be employable as the bit numbers per pixel of the video data of respective screens. The third embodiment provides the same advantages as the first embodiment. Specifically, because the LVDS signal in which the video data of the main-screen M and the video data of the sub-screen S are stored collectively is transmitted, the single transmitter suffices and accordingly the configuration of the computer 2 is simplified.

### Other Embodiments

The above embodiments are not limiting and can be modified and extended in the following ways.

The above illustration is application to a video signal transmission system for a vehicle. However, it may be applied to a video signal transmission system for other uses.

In the above illustration, the LVDS signal is used as a video transmission interface. Alternatively, other video transmission interfaces may be used. For example, HDMI (High-Definition Multimedia Interface, registered trademark), GVIF (Gigabit Video Interface, registered trademark) and the like may be used.

Although embodiments and configurations of the present disclosure are illustrated, embodiments and configurations are not limited to those illustrated above. Embodiments and configurations obtained by appropriately combining technical elements disclosed in different embodiments and configurations are also within the scope of embodiments and configurations of the present disclosure

What is claimed:

1. A video signal transmission system comprising:
one video transmission apparatus for transmitting a video signal; and
one main-display apparatus for displaying a main-screen, wherein:
one or more sub-display apparatuses are connectable between the video transmission apparatus and the main-display apparatus;
the video transmission apparatus transmits the video signal, in which video date of the main-screen and video data of the sub-screen are stored collectively;
the main-display apparatus separates the video data for the main-display apparatus from the video signal received via the sub-display apparatus or received directly from the video transmission apparatus and displays the main-screen; and
in a case where the sub-display apparatus is connected between the video transmission apparatus and the main-display apparatus, the sub-display apparatus separates the video date for the sub-display apparatus from the video signal received from the video transmission apparatus or another sub-display apparatus connected between the sub-display apparatus and the video transmission apparatus and displays the sub-screen and transmits the video signal to the main-display apparatus or yet another sub-display apparatus connected between the sub-display apparatus and the main-display apparatus.

2. The video signal transmission system according to claim 1, wherein:
the video transmission apparatus transmits the video signal in which the video data of the main-screen and the video date of the sub-screen are arranged side by side and which has a resolution corresponding to a total sum of a resolution of the main-screen and a resolution of the sub-screen.

3. The video signal transmission system according to claim 1, wherein:
the video transmission apparatus transmits the video signal in which the video data of the main-screen and the video data of the sub-screen are arranged alternately per pixel.

4. The video signal transmission system according to claim 1, wherein:
the video transmission apparatus transmits the video signal having a bit number per pixel that corresponds to a total sum of a bit number per pixel of the video data of the main-screen and a bit number per pixel of the video data of the sub-screen.

5. A display apparatus functioning as one main-display apparatus in a video signal transmission system,
the signal transmission system including one video transmission apparatus for transmitting a video signal and the one main display apparatus for displaying a main-screen, the signal transmission system being configured such that one or more sub-display apparatuses are connectable between the video transmission apparatus and the main display apparatus and the video transmission apparatus transmits the video signal in which video data of the main-screen and video data of the sub-screen are stored collectively,
the display apparatus comprising:
a main-receiver for receiving the video signal from the video transmission apparatus or from a sub-display apparatus connected between the video transmission apparatus and the main-display apparatus;
a main-separator for separating the video data of the main-screen for the main-display apparatus from the video signal received by the main-receiver; and
a main-display unit for displaying the main-screen based on the video data separated by the main-separator.

6. A display apparatus functioning as a sub-display apparatus in a video signal transmission system,
the video transmission apparatus including
one video transmission apparatus for transmitting a video signal and one main-display apparatus for displaying a main-screen, the video transmission apparatus being configured such that one or more sub-display apparatuses are connectable between the video transmission apparatus and the main-display apparatus and the video transmission apparatus transmits the video signal in which video data of the main-screen and video data of the sub-screen are stored collectively,
the display apparatus comprising:
a sub-receiver for receiving the video signal from the video transmission apparatus or from another sub-display apparatus connected between the display apparatus and the video transmission apparatus;
a sub-separator for separating the video data of the sub-screen from the display apparatus from the video signal received by the sub-receiver;
a sub-display unit for displaying the sub-screen based on the video data separated by the sub-separator; and
a sub-transmitter for transmitting the video signal, which is received by the sub-receiver, to the main-display apparatus or yet another sub-display apparatus connected between the display apparatus and the main-display apparatus.
